(19) United States
(12) Patent Application Publication
(10) Pub. No.: US 2020/0141429 A1
(43) Pub. Date: May 7, 2020

(54) A CONTROL VALVE FOR HYDRAULIC LIFTERS

(71) Applicant: HEMA ENDUSTRI ANONIM SIRKETI, TEKIRDAG (TR)

(72) Inventors: SAMET NAK, TEKIRDAG (TR); OLCAY TEZCAN, TEKIRDAG (TR); OZGUR SAVASCI, TEKIRDAG (TR)

(21) Appl. No.: 16/621,759

(22) PCT Filed: Mar. 26, 2018
(86) PCT No.: PCT/TR2018/050117

§ 371 Date: Dec. 12, 2019

(30) Foreign Application Priority Data
Jun. 15, 2017 (TR) 2017/08846

(51) Int. Cl. F15B 13/04; A01B 63/10; F15B 13/02; F16K 31/00

(52) U.S. Cl. CPC F15B 13/0402; A01B 63/10; F16K 31/00; F15B 13/021; F15B 13/027

(57) ABSTRACT

The present invention relates to a control valve, for hydraulic lifters used on tractors, and having a body (10), at least one main inlet line (11) which transfers fluid into the body (10), and a check valve (23) for controlling the passage of fluid, coming from the main inlet line (11), to a cylinder line (14).

### TECHNICAL FIELD

The present invention relates to a control valve in order to be used in the control of hydraulic lifters in tractors.

### PRIOR ART

In tractors, there are hydraulic lifters generally at the rear part of the tractor. There are control valves in order to control the lifting and lowering functions of hydraulic lifters.

The beginning of the lifting and lowering movement and staying in the neutral position are very important during operation of the control valves. In order to fulfill this with precision, in the present systems, complex systems with pilot warning are applied as can be seen in the application U.S. Pat. No. 6,105,613.

As a result, because of all of the abovementioned problems, an improvement is required in the related technical field.

### BRIEF DESCRIPTION OF THE INVENTION

The present invention relates to a control valve, for eliminating the above mentioned disadvantages and for bringing new advantages to the related technical field.

An object of the present invention is to provide a control valve which is easier to control and where the number of components is reduced.

In order to realize all of the abovementioned objects and the objects which are to be deducted from the detailed description below, the present invention is a control valve, for hydraulic lifters used on tractors, and having a body, at least one main inlet line which transfers fluid into the body, and a check valve for controlling the passage of fluid, coming from the main inlet line, to a cylinder line. Accordingly, the subject matter control valve comprises at least one discharge valve which transfers the fluid, coming from the main inlet line, to a tank line; and at least one lowering valve which transfers the fluid, existing in the cylinder line, to the tank line, depending on the position of a main slide provided in the body.

In a preferred embodiment of the invention, at least one flow control valve is provided which transfers the fluid to the tank line when the fluid pressure in the main inlet line is over a predetermined value.

In a preferred embodiment of the invention, at least one shock valve is provided which transfers the fluid to the tank line when the fluid pressure in the cylinder line is over a predetermined value.

In a preferred embodiment of the invention, at least one throttling valve is provided between the cylinder line and the lowering valve.

### BRIEF DESCRIPTION OF THE FIGURES

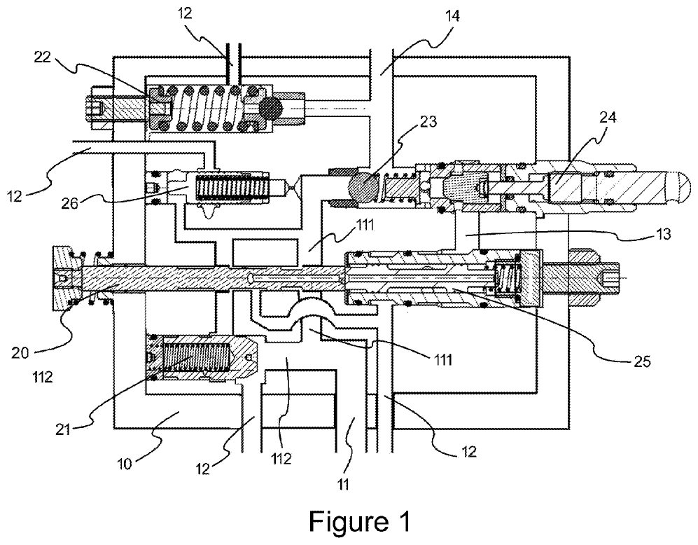

In FIG. 1, a representative schematic view of the subject matter control valve in the neutral position is given.

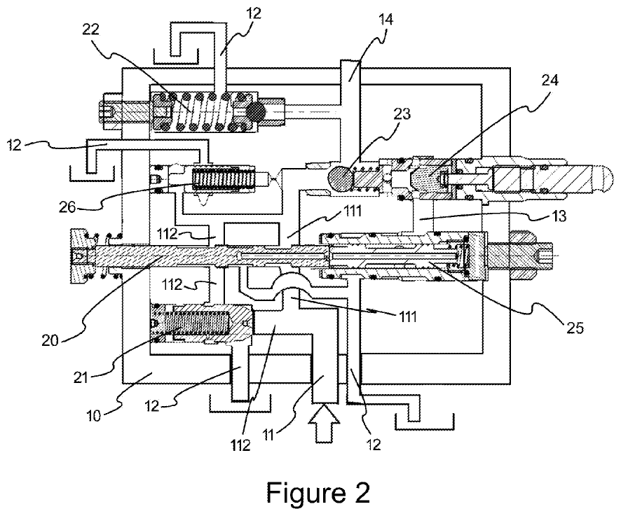

In FIG. 2, a representative schematic view of the subject matter control valve in the lifting position is given.

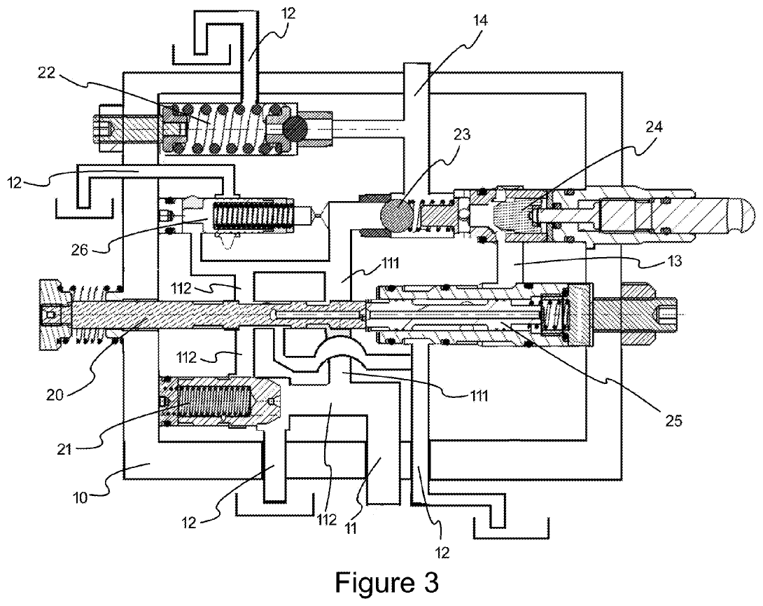

In FIG. 3, a representative schematic view of the subject matter control valve in the lowering position is given.

### DETAILED DESCRIPTION OF THE INVENTION

In this detailed description, the subject matter control valve is explained with references to examples without forming any restrictive effect only in order to make the subject more understandable.

The subject matter control valve has a body (10). There is at least one main slide (20) provided inside the body (10). The main slide (20) is connected to a lowering valve (25). There is at least one main inlet line (11) in order to provide fluid inlet into the body (10). Fluid is continuously transferred from the main inlet line (11) into the control valve. The main inlet line (11) is separated into a first line (111) and a second line (112) in the body (10) and the first line (111) is guided towards a cylinder line (14) and the second line (112) is guided towards a discharge valve (21). Fluid passage is controlled in the first line (111), extending to the cylinder line (14), primarily by means of the main slide (20) and afterwards by means of the check valve (23). The discharge valve (21), which the fluid meets at the second line (112), provides the fluid to advance or provides the fluid to pass to a tank line (12). The second line (112) is interrupted by the main slide (20) at the continuation of the discharge valve (21) and fluid passage is controlled. The second line (112) is separated into two lines after the main slide. While the fluid flowing from the first line (111) passes to the rear side of the flow control valve (26), it reaches the front part of the flow control valve (26) from one side. The fluid, passing the flow control valve (26) opened due to the formed pressure differences, is discharged into a tank line (12).

There is at least one check valve (23) provided between the first line (111) and the cylinder line (14). There is at least one throttling locking valve (24) connected to the check valve (23). There is a lowering line (13) between the throttling locking valve (24) and the lowering valve (25).

As can be seen in FIG. 1, in the neutral position of the control valve, the fluid, coming from the main inlet line (11), advances to the behind of the flow control valve (21) through the first line (111) and advances to the check valve (23). On the other hand, the fluid extends until the front of the flow control valve (26); however, the fluid is prevented from advancing towards the rear of the discharge valve (21) by the main slide (20). Thus, the discharge valve (21) stays in a manner opening the front of the second line (112). By means of this, the fluid, coming from the main inlet line (11), passes to the tank line (12) through the second line (112), which is the easiest route. At the same time, this prevents pressure increase on the first line (111) and the fluid cannot pass the check valve (23). Meanwhile, the fluid, existing in the cylinder line (14), cannot pass towards the first line (111) due to the check valve (23) and the fluid is constrained inside a lowering line (13) between the throttling locking valve (24) and the lowering valve (25). Thus, the position of the cylinder, connected to the cylinder line (14), remains unchanged.

When the main slide (20) is brought to lifting position, the subject matter control valve arrives at the position shown in FIG. 2. In more details, the fluid coming through the first line (111) fills to the rear side of the discharge valve (21) as the main slide on the second line (112) opens the route. By means of this, the discharge valve (21) closes the fluid passage from the second line (112) to the tank line (12) by means of the spring force provided behind. Since the fluid existing in the first line (111) cannot reach the tank line (12), the pressure substantially increases and pushes the check valve (23) and reaches the cylinder line (14).

By means of this, the cylinder connected to the cylinder line (14) creates lifting movement. When excessive pressure is formed due to the load lifted in the cylinder line (14), the fluid passes through a shock valve (22) connected to the cylinder line (14) and reaches the tank line (12) and the system pressure is reduced. Moreover, when the positions where the lifting is to be stopped are approached during lifting, the flow is desired to be decelerated in order to prevent hard stops. In order to provide this, the flow control valve (26) is activated and it transfers some part of the fluid coming from the main inlet line (11) to the tank line (12), and it decreases the amount of fluid transferred to the cylinder line (14).

When the main slide (20) reaches the lowering position, the subject matter control valve reaches the position shown in FIG. 3. The fluid enters through the main inlet line (11) and moves in the same manner as the neutral position and passes to the tank line (12). On the other hand, the main slide (20) moves the lowering valve (25) in a manner passing the fluid coming from the lowering line (13). By means of this, the fluid, existing in the cylinder line (14), passes through the throttling locking valve (24) and through the lowering valve (25) and reaches the tank line (12). Thus, the fluid existing in the cylinder and in the cylinder line (14) advances to the tank line (12). By means of this, the lowering movement is realized.

When the lifting or lowering movement is completed, the main slide (20) is brought to neutral position. By means of this, the fluid coming from the main inlet line (11) is transferred to the tank line (12) and further fluid transfer to the cylinder line (14) is prevented. Moreover, since the check valve (23) and the lowering valve (25) prevent fluid passage, the decrease of the amount of fluid in the cylinder line (14) is prevented, and thus, the position of the lifter, connected to the cylinder, stays fixed.

Thanks to the flow control valve (26) provided in the control valve, when the difference of fluid pressure existing at the front and rear thereof is over the desired value during lifting, the flow control valve (26) provides the fluid to pass to the tank line (12). When the fluid passes to the tank line (12), the pressure difference decreases and the flow control valve (26) again arrives at the position where fluid passage is prevented.

The throttling locking valve (24) provides adjusting of the lowering speed by means of decreasing and increasing the area where the oil will pass during lowering, and when it is locked till the end, the oil, existing in the cylinder, stays in the cylinder even if the lowering valve (25) is passed to lowering mode, and said throttling locking valve (24) provides the lowering process not to be realized.

The protection scope of the present invention is set forth in the annexed Claims and cannot be restricted to the illustrative disclosures given above, under the detailed description. It is because a person skilled in the relevant art can obviously produce similar embodiments under the light of the foregoing disclosures, without departing from the main principles of the present invention.

### REFERENCE NUMBERS

10 Body
11 Main inlet line
111 First line
112 Second line
12 Tank line
13 Lowering line
14 Cylinder line
20 Main slide
21 Discharge valve
22 Shock valve
23 Check valve
24 Throttling locking valve
25 Lowering valve
26 Flow control valve

1. A control valve, for hydraulic lifters used on tractors, and having a body (10), at least one main inlet line (11) which transfers fluid into the body (10), and a check valve (23) for controlling the passage of fluid, coming from the main inlet line (11), to a cylinder line (14); characterized by comprising at least one discharge valve (21) which transfers the fluid, coming from the main inlet line (11), to a tank line (12); and at least one lowering valve (25) which transfers the fluid, existing in the cylinder line (14), to the tank line (12), depending on the position of a main slide (20) provided in the body (10).

2. A control valve according to claim 1, wherein at least one flow control valve (26) is provided which transfers the fluid to the tank line (12) when the fluid pressure difference between the first line (111) and the second line (112), which are the arms of the main input line (11), is over a predetermined value.

3. A control valve according to claim 1, wherein at least one shock valve (22) is provided which transfers the fluid to the tank line (12) when the fluid pressure in the cylinder line (14) is over a predetermined value.

4. A control valve according to claim 1, wherein at least one throttling valve (24) is provided between the cylinder line (14) and the lowering valve (25).
